(19) United States
(12) Patent Application Publication
(10) Pub. No.: US 2006/0000058 A1
(43) Pub. Date: Jan. 5, 2006

(54) Block and tackle window balance with integrally molded middle carriage assembly and cord

(75) Inventor: Jefferey Charles Robertson, Rochester, NY (US)

Correspondence Address: BROWN & MICHAELS, PC;400 M & T BANK BUILDING, 118 NORTH TIOGA ST, ITHACA, NY, 14850, US

(73) Assignee: Caldwell Manufacturing Company, Rochester, NY (US)

(21) Appl. No.: 11/157,290

(22) Filed: Jun. 21, 2005

Related U.S. Application Data
(60) Provisional application No. 60/581,477, filed on Jun. 21, 2004.

(51) Int. Cl. E05D 13/00

(52) U.S. Cl. 16/197

(57) ABSTRACT

This block and tackle window balance is based on molding a middle carriage pulley body and a cord terminal (or anchor) in a tip-to-tip position on a cord with each molded pair spaced appropriately from the next molded pair. When the cord is severed between tips, segments of cord are created with a middle carriage body already molded/connected at one end and a terminal already molded/connected at the other end and facing in the opposite direction. The molded middle carriage block component provides for attachment of the middle carriage block to the balance spring, receives a sheave and supports the sheave for rotation, retains the sash cord within sheaves, and guides the middle carriage assembly in its travel along the balance channel. The shape of its terminal provides and facilitates the ease with which the balance cord can be connected to other operative portions of the window frame or assembly. A novel snap-together sheave pair is utilized to simplify balance assembly.

### REFERENCE TO RELATED APPLICATIONS

This application claims an invention which was disclosed in Provisional Application No. 60/581,477, filed 21 Jun. 2004, entitled “Block and Tackle Window Balance with integrally Molded Middle Carriage Assembly and Cord”. The benefit under 35 USC §119(e) of the United States provisional application is hereby claimed, and the aforementioned application is hereby incorporated herein by reference.

### FIELD OF THE INVENTION

My invention pertains generally to the field of block and tackle window balances. More specifically, it relates to the pulley, cord and terminal systems used in such window balances.

### BACKGROUND OF THE INVENTION

Block and tackle window balances are compact in size and relatively easy to install. They use a system of pulleys and an extension spring to convert high spring tension applied over a short working distance to a lower spring tension applied over a longer working distance. Both the spring and the pulley system are arranged within a rigid U-shaped balance channel. One end of the extension spring is anchored at a first end of the balance channel, while the other end of the extension spring is mounted to an intermediate pulley (or middle carriage) of the pulley system. The second (end) pulley of the pulley system is anchored at the second end of the balance channel. Generally, the balance channel is mounted in the jamb of the window frame and the cord for the pulley system is attached to a sash shoe that slides in the jamb with the sash. However, this arrangement can be reversed with the cord anchored to the top of the frame and the sash shoe anchored to the opposite end of the balance channel. In all cases, the extension spring and the pulley system are sized so that a desired lifting force is applied to the window sash throughout the entire range of sash travel in the window frame. Examples typical of the art in this area can be found in the following U.S. patents:
U.S. Pat. No. 3,358,403 issued to Dinsmore for a “Heavy Window Balance Assembly” in 1967.
U.S. Pat. No. 4,642,845 issued to Marshik for a “Balance Assembly for a Window” in 1987.
U.S. Pat. No. 5,530,991 issued to deNormand et al. for a “Block and Tackle Window Balance” in 1996.
U.S. Pat. No. 5,737,877 issued to Meunier et al. for a “Block and Tackle Balance with Integral, Non-Rotating Pulley System” in 1998.
U.S. Pat. No. 6,041,476 issued to deNormand for an “Inverted Block and Tackle Window Balance” in 2000.

Dinsmore discloses a block and tackle window balance having a sash cord that passes alternatively over rotating sheaves positioned proximate the end of its rigid channel and rotating sheaves within an carriage assembly affixed to one end of a coil spring to form (as is typical) a tackle with five active parts. Dinsmore also teaches attachment of the sash cord to the carriage assembly and to the cord termination element by knotting the cord. Marshik discloses a block and tackle window balance powered by a gas spring and having a multipart tackle wherein the axis of a first group of sheaves is oriented at a right angle to the axis of a second group of sheaves. DeNormand et al. disclose a spring coupling, with two axle halves affixed to opposite sides, each axle half receiving a sheave and supporting it for rotation. This patent also teaches attachment of the cord to the spring coupling by means of a ring-shaped terminal affixed to the end of the sash cord. Meunier et al. teach attachment of the sash cord to the appropriate balance components by knotting. Finally, in U.S. Pat. No. 6,041,476, DeNormand discloses the structure of an end axle assembly and techniques for affixing the end axle assembly to a balance channel.

As should be clear from review of the foregoing, the art in this field is well developed, but still leaves abundant room for improvement. This is particularly true in terms of reducing the number of parts involved, reducing the complexity of the structures used, and simplifying overall structure, construction, and assembly

### SUMMARY OF THE INVENTION

My invention introduces several important innovations to this field. In general, it is based on molding a middle carriage pulley body and a cord terminal (or anchor) in a tip-to-tip position on a cord with each molded pair spaced appropriately from the next molded pair. When the cord is severed between tips, segments of cord are created with a middle carriage body already molded/connected at one end and a terminal already molded/connected at the other end and facing in the opposite direction. The molded middle carriage block component provides for attachment of the middle carriage block to the balance spring, receives a sheave that it supports for rotation, retains the sash cord within sheaves, and guides the middle carriage assembly in its travel along the balance channel. The terminal provides and facilitates the ease with which the balance cord can be connected to other operative portions of the window frame or assembly. Its unique shape facilitates its functionality in these areas and it can be used in cord terminals that are not molded to the cord as in the preferred embodiments discussed herein. In addition to the foregoing, a novel sheave pair is utilized in my invention to simplify balance assembly. Finally, my middle carriage assembly is substantially shorter than current art carriages, thus enabling the use of a longer sash cord, which can provide a greater balance travel capability. These and other benefits of my invention will become obvious upon review of the text that follows and its accompanying drawing figures.

### BRIEF DESCRIPTION OF THE DRAWING

FIG. 1 provides a perspective view of a block and tackle balance produced in accordance with the teachings of my invention.

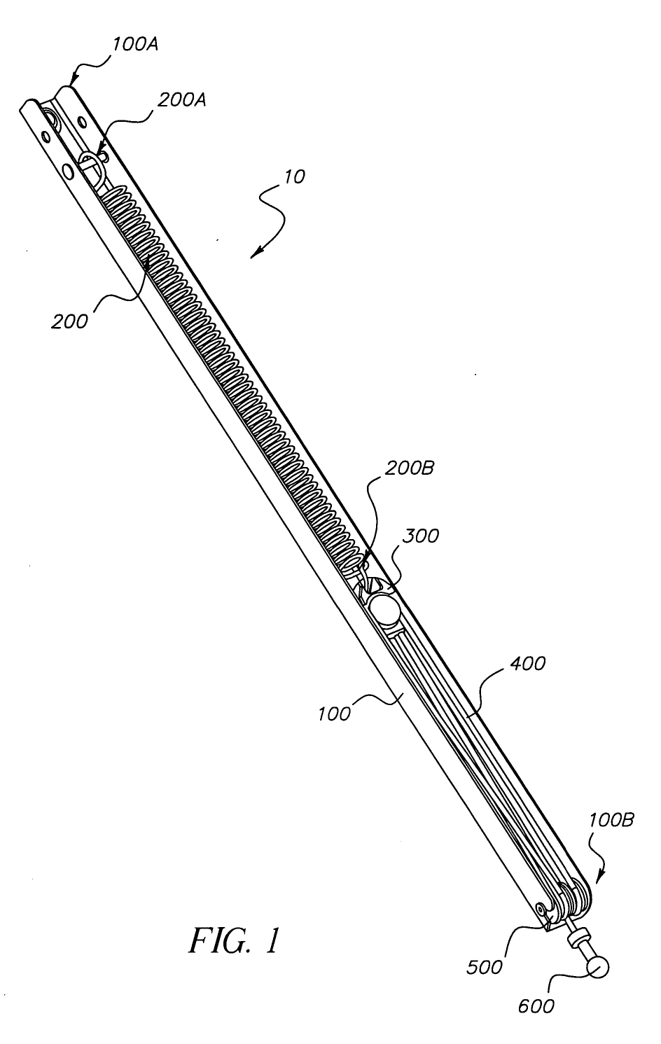

FIG. 2 provides a perspective view of a portion of my invention's sash cord with molded cord terminal and middle carriage block, showing the top of the middle carriage block.

FIG. 3 is a cross section of the sash cord, cord terminal, and middle carriage block of FIG. 2, taken through the centerline of the sash cord.

FIG. 4 provides a perspective view of the sash cord, cord terminal, and middle carriage block of FIG. 2, showing the bottom of the middle carriage block.

FIG. 5 provides a perspective view of a first sheave used in the construction of the block and tackle balance of FIG. 1.

FIG. 6 is a front cross-sectional view of a second sheave used in the construction of the block and tackle balance of FIG. 1.

FIG. 7 is an enlarged back view of a portion of the block and tackle balance of FIG. 1, showing the middle carriage assembly.

FIG. 8 is a cross-sectional view of the middle carriage assembly taken along line 8-8 of FIG. 7, with the channel omitted for clarity.

FIG. 9 provides a perspective back view of a portion of the block and tackle balance of FIG. 1, showing the middle carriage, end axle, and sash cord, with the channel omitted for clarity.

FIG. 10 provides a perspective front view of the portion of a block and tackle balance shown in FIG. 9.

FIG. 11 provides a perspective view of a portion of my invention's sash cord with two insert molded cord terminals.

FIG. 12 provides a perspective view of a middle carriage assembly 15 designed to attach to a molded cord terminal.

FIG. 13 provides a perspective view of a middle carriage assembly with integral cord grooves for a high friction balance.

FIG. 14 provides a perspective view of the cord terminal of my invention connected to a typical prior art carrier.

### DETAILED DESCRIPTION OF THE INVENTION

A block and tackle balance 10 is constructed from a channel 100, commonly formed from sheet metal, into which is assembled a spring 200. First spring end 200A of spring 200 is affixed by various means proximate a first end 100A of channel 100. Second spring end 200B of spring 200 is attached to a middle carriage 300, said middle carriage 300 comprising the first portion of a multi-part balance tackle assembly. An end axle 500, comprising a second portion of said multipart balance tackle assembly is affixed proximate a second end 100B of channel 100. In commonly available block and tackle balances, a sash cord 400 is affixed at one end to middle carriage 300 and twice passes alternatively around sheaves comprising end axle 500 and middle carriage 300, exiting finally at the second end 100B of channel 100, to form a five-part balance tackle assembly.

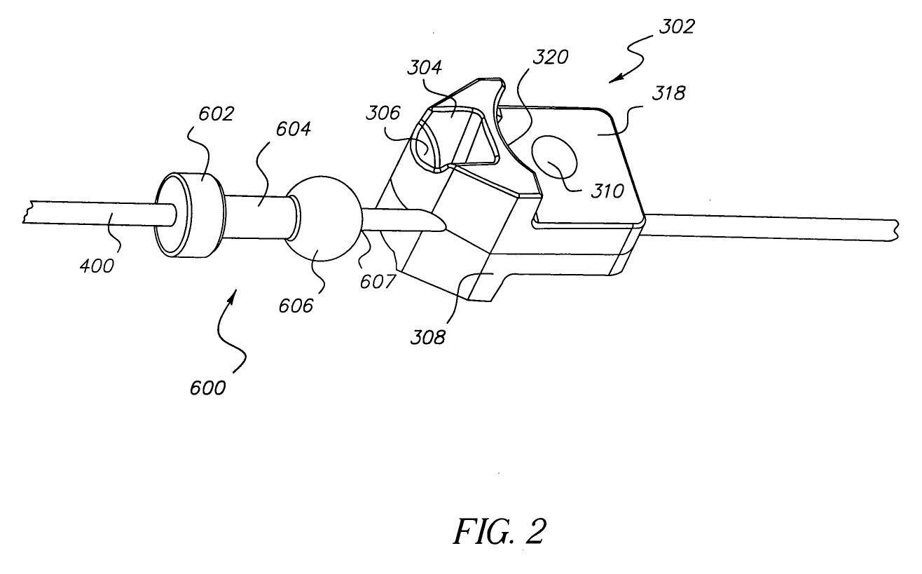

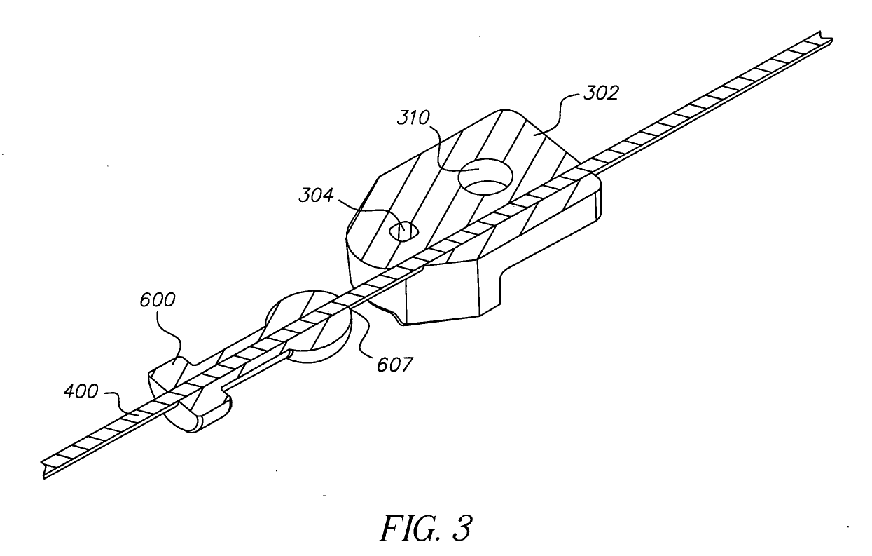

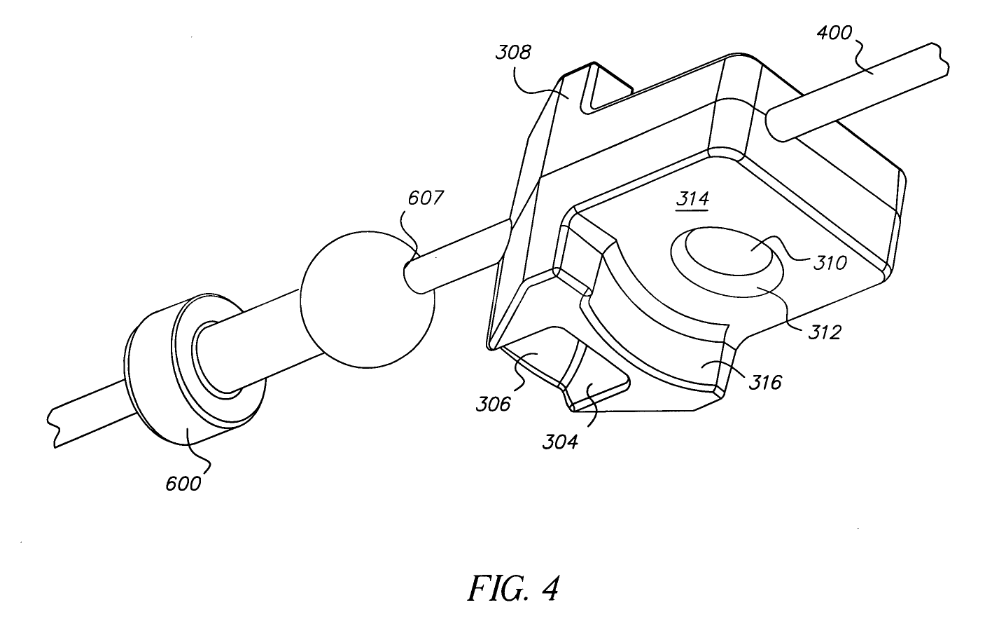

When the exiting end of sash cord 400 is extended beyond the second end of channel 100, the tackle assembly comprising middle carriage 300, end axle 500, and sash cord 400 is shortened and spring 200 is stretched, creating the desired restorative or counterbalancing force. Thus, when in use as a window sash balance, the first end 100A of channel 100 can be affixed within a window frame, and sash cord 400 can be affixed to a vertically sliding sash, to counterbalance the weight of the sash. A cord terminal 600 is affixed to the second end of sash cord 400, to facilitate attachment of the sash cord in the application of the counterbalance and to prevent the second end of the sash cord 400 from being retracted into the second end of channel 100. Middle carriage 300 and cord terminal 600 are formed by injection molding plastic materials directly around sash cord 400. This allows a reduction in the number of parts needed to construct a block and tackle balance, a simplification of the manufacturing steps required to produce the balance, and an improvement in the integrity of the cord attachment to the middle carriage and to the cord terminal. Thus, in FIGS. 2 through 4, cord terminal 600 and middle carriage block 302 are formed from a plastic material by injection molding directly onto a portion of sash cord 400. Separate proximate cavities within the injection mold are utilized to form both cord terminal 600 and middle carriage block 302 in the same cycle or shot. Semi-circular grooves cut across both faces of the mold, in alignment with the cavities, allow a continuous length of sash cord 400 to be fed through the mold. At the end of each mold cycle, the mold opens and sash cord 400 is advanced an appropriate distance. Thus, when sash cord 400 is severed between proximate cord terminal-carriage block pairs, the length of sash cord 400 between a middle carriage block 302 on a first end of a sash cord 400 segment and the cord terminal 600 on the second end of a sash cord 400 segment is appropriate for the block and tackle balance for which it is intended.

Given the intense pressures common to the injection molding process and the shrinkage of plastic materials as they cool within a mold, cord terminal 600 and middle carriage block 302 develop an intimate and strong grip on sash cord 400. Measurement of the force required to pull sash cord 400 free of either cord terminal 600 or middle carriage block 302 consistently results in values greater than 100 pounds. Similar measurements of commonly available crimped metallic cord terminations gave force values in the range of 70 to 90 pounds. (Termination by knotting typically results in forces close to the breaking strength of the cord, but knots have the potential to slip and are difficult to form reliably and quickly in a production process.) In addition, resistance to cord pullout can be increased when sash cord 400 is manufactured from a synthetic material (such as polyester) if severance of sash cord 400 is accomplished with the aid of a hot cutting tool. This melts and fuses the fibers at the point of severance, creating an enlarged end that is difficult to pull through middle carriage block 302 or cord terminal 600. However, it remains possible to join cord terminal 600 to sash cord 400 by other means even though it is not preferred in this invention.

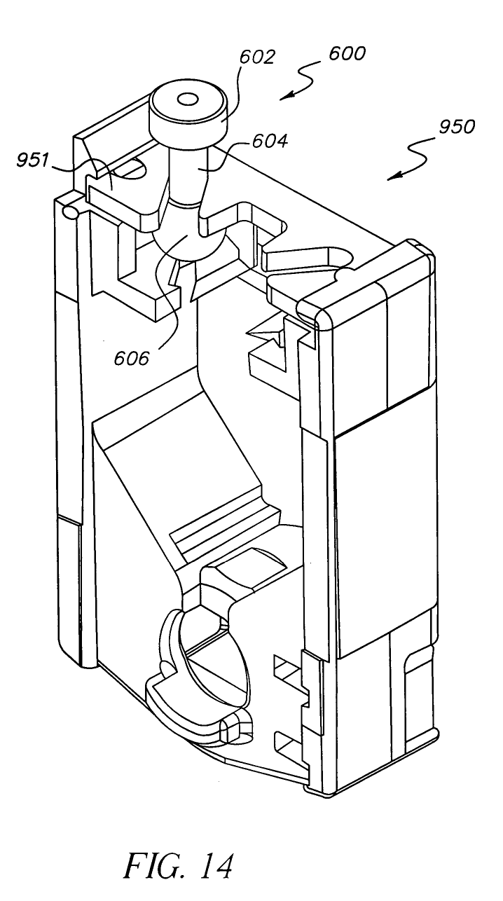

In the preferred embodiment, cord terminal 600 is advantageously formed with an enlarged proximal end section (shoulder 602), an enlarged distal end section (ball 606), and a narrower intermediate section (shank 604). This shape is preferred as it facilitates easy snap-in connection with a standard carrier 950 as illustrated in FIG. 14. In addition, shoulder 602 keeps the terminal from being withdrawn into the balance, retaining shank 604 in a position exterior to the balance channel where it can be easily accessed for insertion into a carrier 950. (However, cord terminal 600 could take a variety of other shapes in keeping with its role as an anchor or hook.) Shoulder 602 is designed to pull up against the second end of channel 100 to prevent sash cord 400 from retracting into channel 100. When applied to the task of counterbalancing, cord terminal 600 can pull upward against the slotted bracket 951 of a carrier 950 attached to a window sash. Overall, shoulder 602, shank 604 and ball 606 form small diameter/large diameter configurations that can be used to facilitate gripping or attaching the cord end of the balance to a bracket attached to a window part or to receive adaptive parts such as specialized hooks or other attachment devices that could be added to the balance by crimping or snapping onto shank 604.

Middle carriage block 302 is formed with a spring eye 304 having a spring loop surface 306, shaped to conform with and support spring loop 202, when middle carriage block 302 is assembled to spring 200 in the fabrication of block and tackle balance 10. Middle carriage block 302 also has a guide portion 308, wherein the transverse cross-sectional shape approximates the interior shape of channel 100 and is sized to allow middle carriage block 302 to slide along the interior of channel 200, while preventing the rotation of middle carriage block 302 about an axis parallel to the length of channel 200.

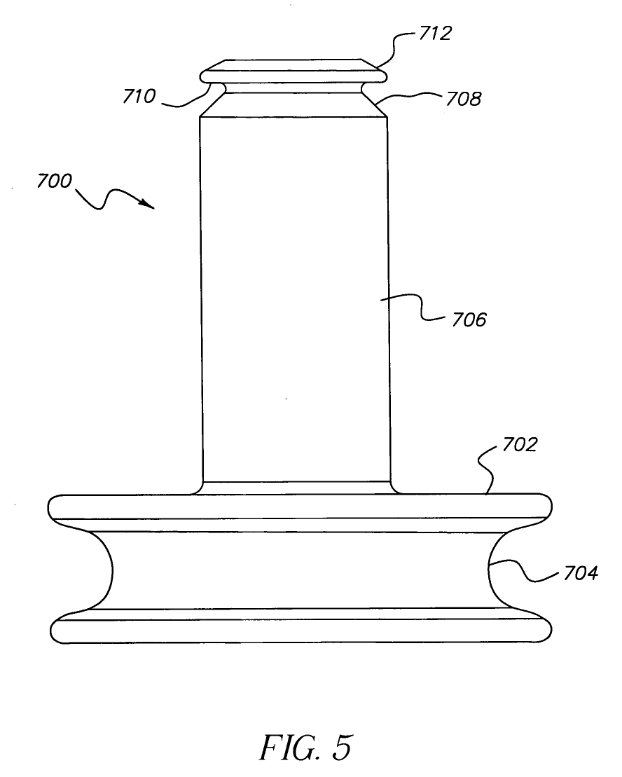

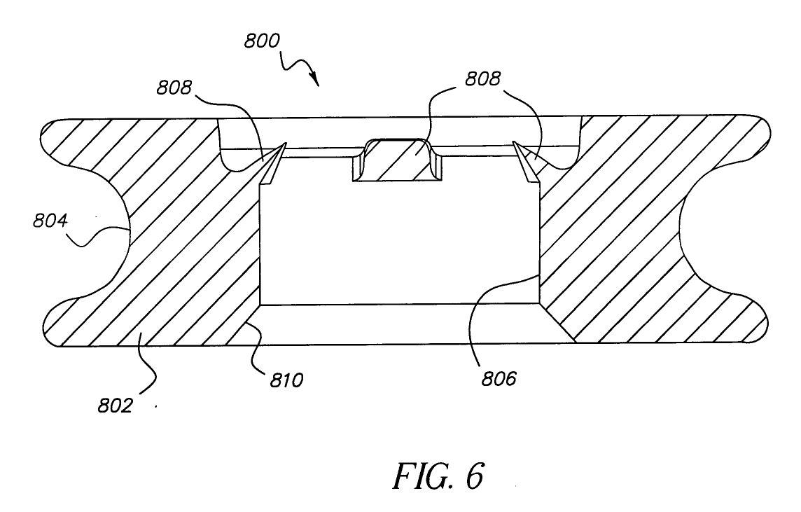

FIGS. 5 through 6 illustrate the sheaves used as cord guiding members for sash cord 500. First sheave 700 has a sheave body 702 (with a cord groove 704) and a shaft 706 (with snap groove 708 and chamfer 712). A second sheave 800 comprises a body 802, with groove 804 and sheave journal 806. A plurality of snap fingers 808 encroach within sheave journal 806, and sheave chamfer 810 facilitates assembly. These parts can all be produced simply and easily using die casting techniques of other standard molding techniques.

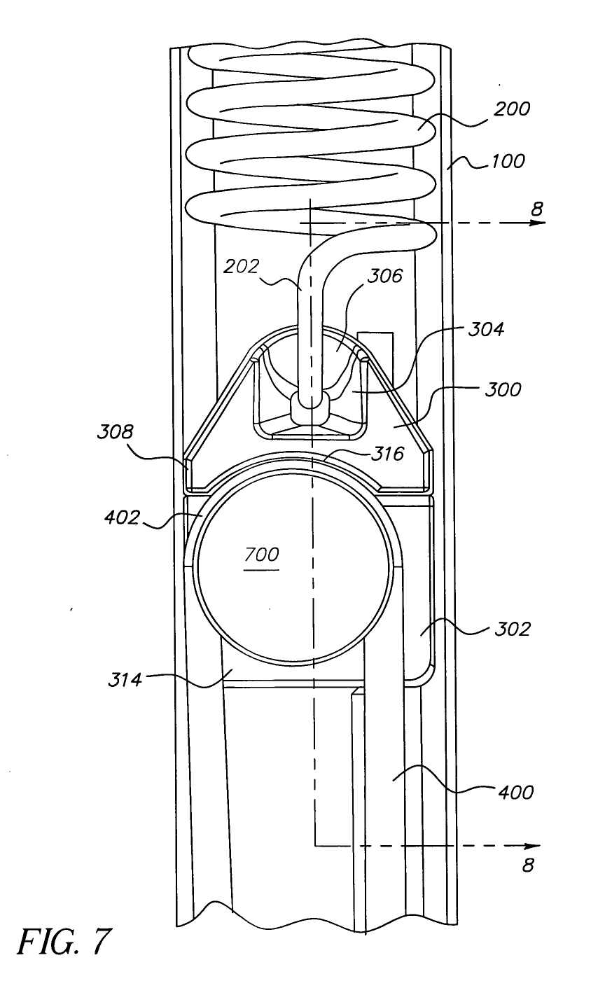

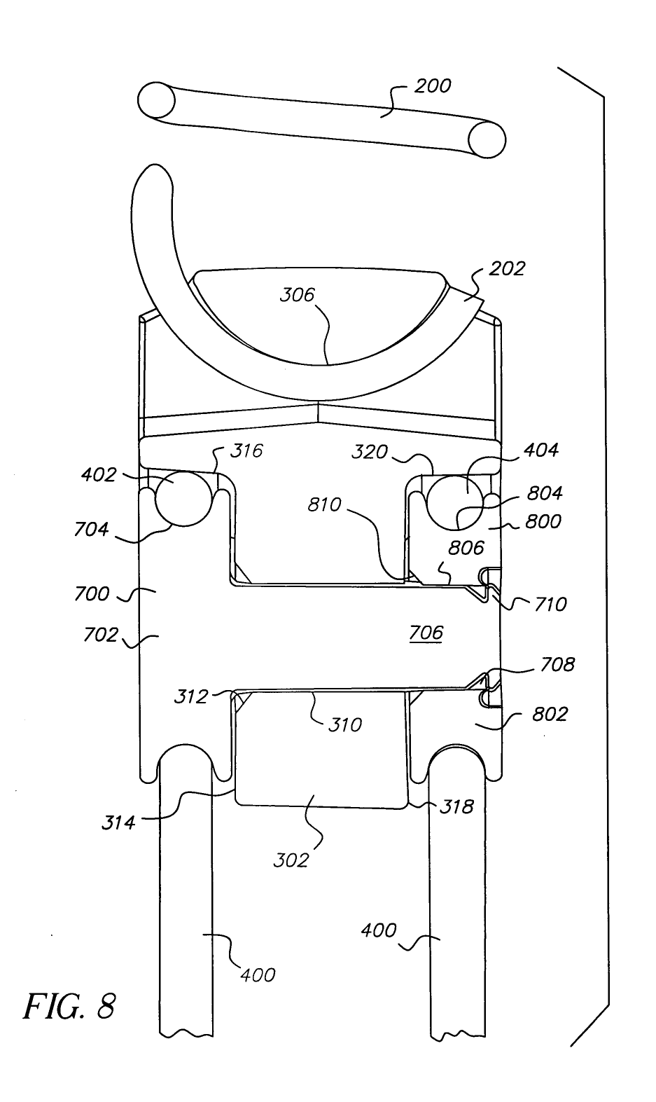

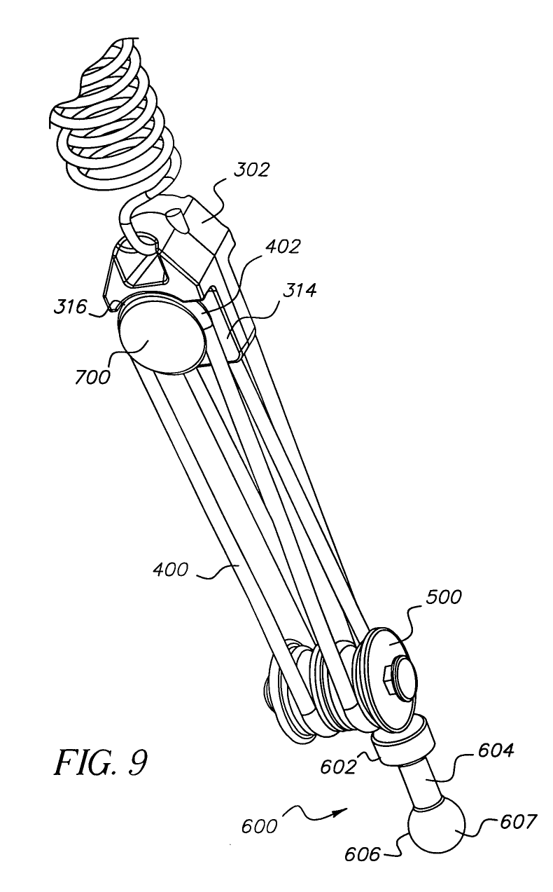

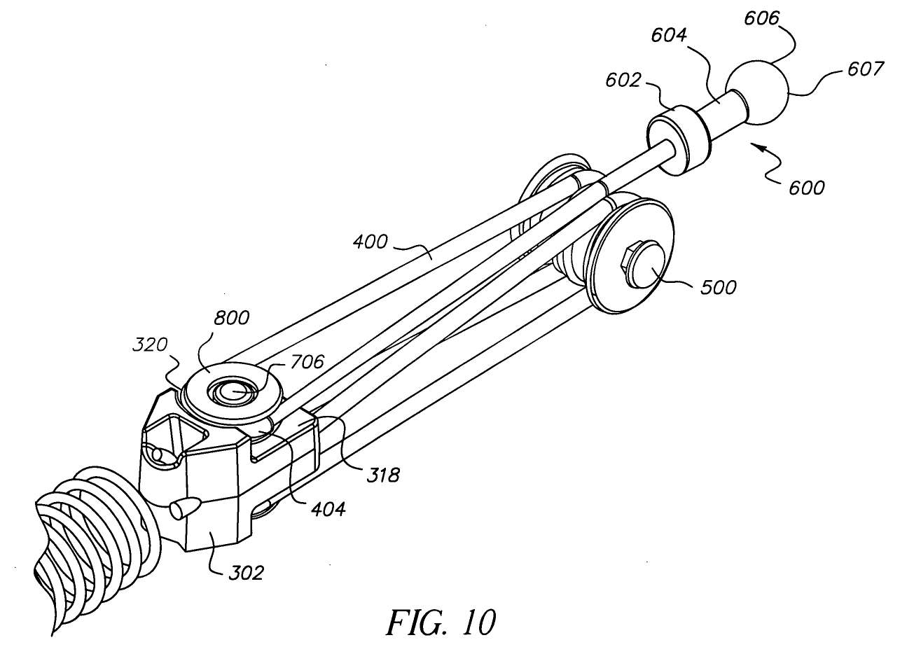

Referring now to FIGS. 7 through 10, the steps for lacing block and tackle balance 10 will now be described. First, sash cord 400 is passed once around end axle 500 and then once around first sheave 700, forming a first loop 402, lying within cord groove 704 of sheave 700. This first step is performed prior to the insertion of shaft 706 into journal 310 of middle carriage block 302 or when shaft 706 is only partially inserted into journal 310. Second, shaft 706 of first sheave 700 is fully inserted into journal 310 of middle carriage block 302, with sheave body 702 resting within first sheave pocket 314 of middle carriage block 302, and first loop 402 of sash cord 400 entrapped within cord groove 704 of first sheave 700, by first retainer surface 316 of middle carriage block 302. Third, sash cord 400 is again passed once around end axle 500, and thence, once around second sheave 800, forming a second loop 404, lying within groove 804 of sheave 800, prior to the assembly of sheave 800 to middle carriage 300. Fourth, sheave journal 806 of second sheave 800 is assembled over shaft 706 of first sheave 700, with body 802 of sheave 800 resting in second sheave pocket 318 of middle carriage block 302, and second loop 404 of sash cord 400 entrapped within groove 804 of second sheave 800 by second retainer surface 320 of middle carriage block 302.

When second sheave 800 is assembled onto shaft 706 of first sheave 700, snap fingers 808 resiliently retract, then rebound, within snap groove 708 under snap lip 710, to retain first sheave 700 and second sheave 800 in their assembled relationship. Journal chamfer 312 of middle carriage block 302 and chamfer 712 of first sheave 700 help guide shaft 706 of first sheave 700 into journal 310 of middle carriage block 302. Likewise, sheave chamfer 810 of second sheave 800 helps guide sheave journal 806 onto shaft 706 of first sheave 700. Finally, to complete the assembly of block and tackle balance 10, spring loop 202 of spring 200 is rove through spring eye 304 of middle carriage block 302, channel 100 is engaged with end axle 500, and the first end of spring 200 is affixed to the first end of channel 100.

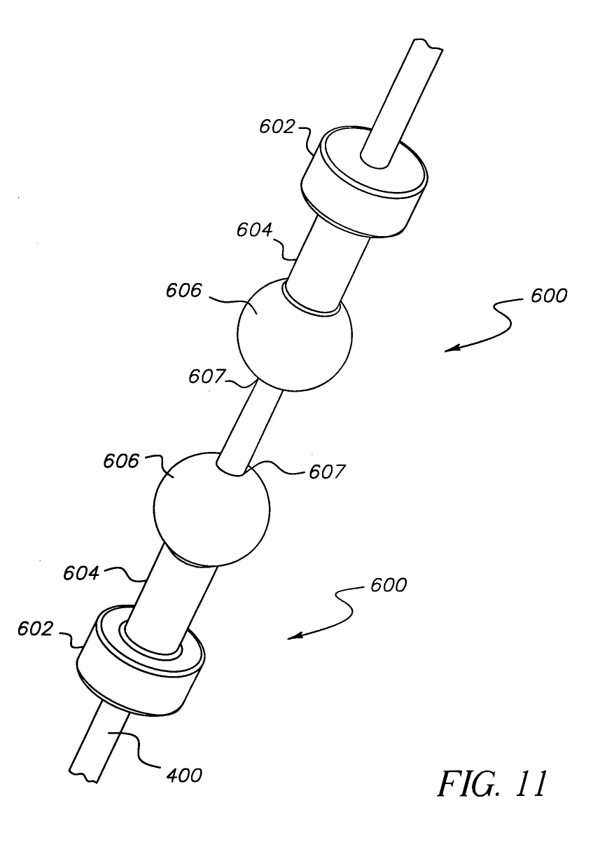

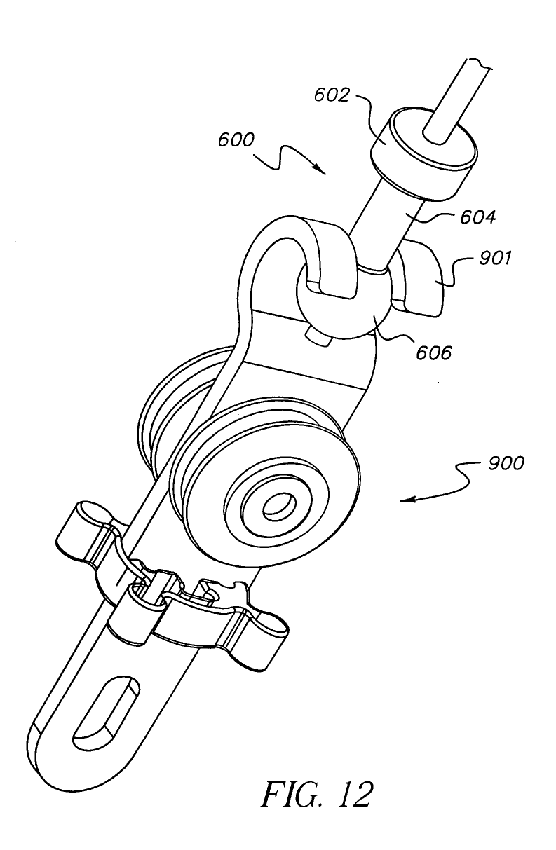

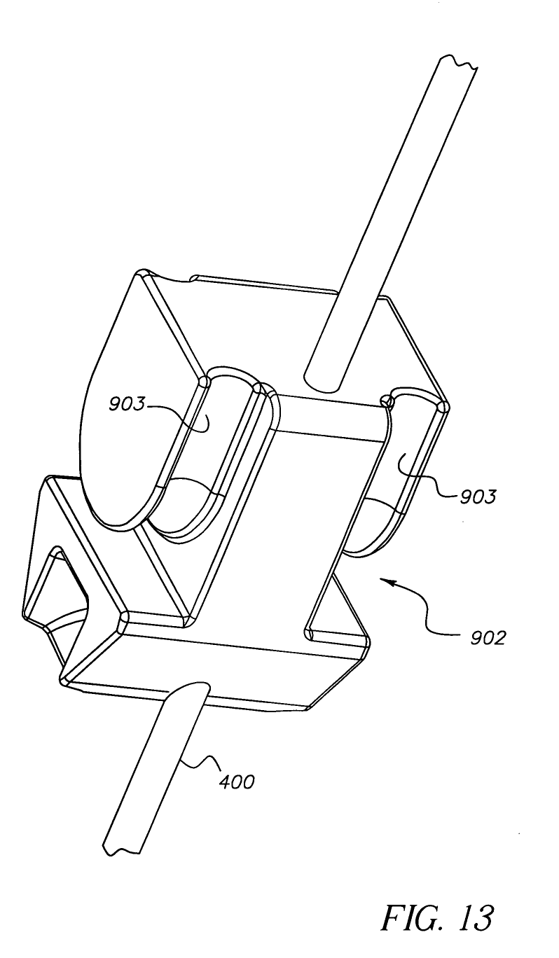

Some possible alternate embodiments are shown in FIGS. 11 through 13. In FIG. 11, two terminals 600 form a molding pair on a sash cord 400. As shown in FIG. 12, this embodiment allows the use of an alternate middle carriage 900 with a catch 901 to which one of the terminals 600 can be attached. Further, although identical terminals are illustrated, terminals 600 can take different shapes and forms as required by the application. (Thus, this alternative avoids the use of a middle carriage 300 molded around sash cord 400.) Another alternative middle carriage, frictional balance carriage 902, is illustrated in FIG. 13. Frictional balance carriage 902 is molded with integral cord grooves 903 so as to form a high friction balance. However, while a novel block and tackle balance assembly and certain variations have been described, it should be understood that the invention is not limited to the above specific embodiments. Many additional variations can be made without exceeding the scope of the invention, as more clearly delineated in the claims that follow.

What is claimed is:

1. A window balance comprising a cord and at least one of a middle carriage body and a cord terminal molded around said cord.

2. A window balance as described in claim 1, wherein both a middle carriage body and a cord terminal are molded around said cord.

3. A window balance as described in claim 1, wherein said body is formed with frictional balance cord grooves.

4. A window balance as described in claim 1, wherein at least one cord terminal is molded around said cord, and said body is not molded around said cord but is provided with a catch for connecting the body to a cord terminal.

5. A window balance as described in claim 1, wherein said body is formed with a carriage shaft journal, said carriage shaft journal being adapted to receive a pulley shaft.

6. A window balance as described in claim 1, further comprising a guide channel elongated along an axis, and wherein said body is formed so as to slide along the axis of said guide channel without rotation.

7. A window balance as described in claim 5, further including a molded pulley sheave and shaft combination, said combination comprising a pulley sheave coaxially connected to an end of the pulley shaft, the pulley shaft being mountable in said carriage shaft journal.

8. A window balance as described in claim 7, further including another pulley sheave connectable to an other end of said pulley shaft opposite the sheave of said combination.

9. A window balance as described in claim 8, wherein said other pulley sheave is connectable by a snap connection.

10. A window balance as described in claim 8, wherein said other pulley sheave is formed with a pulley sheave journal adapted to receive the other end of said pulley shaft.

11. A window balance as described in claim 1, wherein a cord terminal is molded around said cord and said cord is attached to a middle carriage body via said cord terminal.

12. A window balance as described in claim 1, wherein said cord terminal has at least one of an enlarged proximal end section and an enlarged distal end section, said end sections being connected by a narrower intermediate section.

13. A window balance as described in claim 12, wherein at least one of said proximal end section and said distal end section includes a substantially cylindrical portion.

14. A window balance as described in claim 12, wherein at least one of said proximal end section and said distal end section includes a substantially spherical portion.

15. A window balance as described in claim 12, wherein said intermediate section is substantially cylindrical.

16. A method for manufacturing window balances, comprising molding at least one of a middle carriage body and a cord terminal around a cord for a block and tackle balance.

17. A method for manufacturing window balances as described in claim 16, wherein both a body and a terminal are molded around the cord, said body has a spring connection end and said terminal has a distal end with the spring connection end and the distal end being proximate each other when said body and said terminal are molded around the cord, and each such body and terminal define a molding pair.

18. A method for manufacturing window balances as described in claim 17, further comprising severing a portion of the cord extending between the distal end and the spring connection end of a molding pair.

19. A method for manufacturing window balances as described in claim 18, further comprising forming an other molding pair and severing a portion of cord extending between a distal end and a spring connection end of said other molding pair such that at least one length of cord with a body at one end and a terminal at an other end is formed.

20. A method for manufacturing window balances as described in claim 16, wherein said body is formed with a carriage shaft journal, said carriage shaft journal being adapted to receive a pulley shaft.

21. A method for manufacturing window balances as described in claim 20, further comprising molding a pulley sheave and shaft combination, said combination comprising a pulley sheave co-axially connected to an end of the pulley shaft, the pulley shaft being mountable in said carriage shaft journal.

22. A method for manufacturing window balances as described in claim 21, further comprising molding another pulley sheave connectable to an other end of said pulley shaft opposite the sheave of said combination.

23. A method for manufacturing window balances as described in claim 22, wherein said other pulley sheave is connectable by a snap connection.

24. A method for manufacturing window balances as described in claim 21, further comprising mounting said pulley shaft in said carriage shaft journal and connecting said other pulley sheave to said other end of said pulley shaft opposite the sheave of said combination.

25. A method for manufacturing window balances as described in claim 16, further comprising producing pulley sheaves connectable to said carriage body.

26. A method for manufacturing window balances as described in claim 16, wherein said cord terminal has at least one of an enlarged proximal end section and an enlarged distal end section, said end sections being connected by a narrower intermediate section.

27. A method for manufacturing window balances as described in claim 26, wherein at least one of said proximal end section and said distal end section includes a substantially cylindrical portion.

28. A method for manufacturing window balances as described in claim 26, wherein at least one of said proximal end section and said distal end section includes a substantially spherical portion.

29. A method for manufacturing window balances as described in claim 26, wherein said intermediate section is substantially cylindrical.

30. A window balance comprising a cord and a cord terminal attached to said cord, wherein said cord terminal has at least one of an enlarged proximal end section and an enlarged distal end section, said end sections being connected by a narrower intermediate section.

31. A window balance as described in claim 30, wherein at least one of said proximal end section and said distal end section includes a substantially cylindrical portion.

32. A window balance as described in claim 30, wherein at least one of said proximal end section and said distal end section includes a substantially spherical portion.

33. A window balance as described in claim 30, wherein said intermediate section is substantially cylindrical.
